(19) United States
(12) Patent Application Publication
(10) Pub. No.: US 2008/0151098 A1
(43) Pub. Date: Jun. 26, 2008

(54) CAMERA MODULE

(75) Inventor: SHENG-JUNG YU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/957,314

(22) Filed: Dec. 14, 2007

(30) Foreign Application Priority Data
Dec. 20, 2006 (CN) 200610157699.8

(51) Int. Cl. H04N 5/335; H04N 5/225; H04N 5/232; G03B 13/00

(52) U.S. Cl. 348/374; 348/340; 348/357

(57) ABSTRACT

A camera module (10), includes a lens holder (12) having an aperture (1202), at least one lens module (11) threadedly installed in the lens holder, and a motor (13) mounted on the lens holder. The motor includes a rotor (132) and an endless belt (14), wherein the endless belt extends through the aperture and surrounds the lens module, and the rotor. The motor is configured for driving the lens module to move relative to the lens holder.

### BACKGROUND

1. Technical Field

The present invention relates to camera modules, and particularly to a camera module with an auto focus mechanism.

2. Description of Related Art

In recent years, camera modules for taking photos have been incorporated in mobile terminals, such as mobile phones and lap-top computers. Most mobile terminals devices are, progressively becoming more miniaturized over time, and digital camera modules are, correspondingly, becoming smaller and smaller. Nevertheless, in spite of the small size of a contemporary digital camera module, consumer still demands advantageous properties of the camera module, such as auto focus function.

A camera module generally includes at least one lens module and an image sensor module in alignment with the at least one lens module. The at least one lens module typically includes a lens barrel and lenses assembled in the lens barrel. Recently, camera modules have employed auto focus mechanisms, such as step motors for driving the lenses by screws to move relative to the image sensor module, thereby achieving the auto focus function. However, the total length required for such camera module is so large that the size reduction requirement of the camera module is not easy to be satisfied.

What is needed, therefore, is a camera module which has a simple and small sized auto focus mechanism.

### SUMMARY

In a present embodiment, a camera module, includes a lens holder having an aperture, at least one lens module threadedly installed in the lens holder, and a motor mounted on the lens holder. The motor includes a rotor and an endless belt, wherein the endless belt extends through the aperture and surrounds the lens module, and the rotor. The motor is configured for driving the lens module to move relative to the lens holder.

Other advantages and novel features of the present invention will become more apparent from the following detailed description of preferred embodiment when taken in conjunction with the accompanying drawings.

### BRIEF DESCRIPTION OF THE DRAWINGS

Many aspects of the lens module can be better understood with reference to the following drawings. The components in the drawing are not necessarily drawn to scale, the emphasis instead being placed upon clearly illustrating the principles of the present lens module. Moreover, in the drawings, like reference numerals designate corresponding parts throughout the several views.

FIG. 1 is a perspective view of a camera module according to a first embodiment of the present invention.

FIG. 2 is a cross-sectional view taken along line II-II of FIG. 1.

FIG. 3 is a schematic, cross-sectional view of a camera module according to a second embodiment of the present invention.

### DETAILED DESCRIPTION OF THE PREFERRED EMBODIMENTS

Embodiments of the present lens module will now be described in detail below and with reference to the drawings.

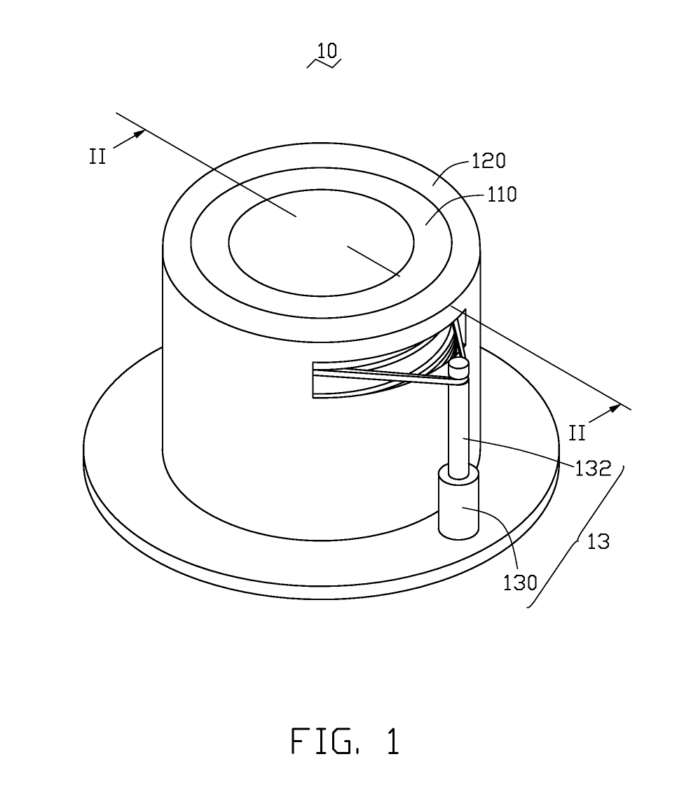

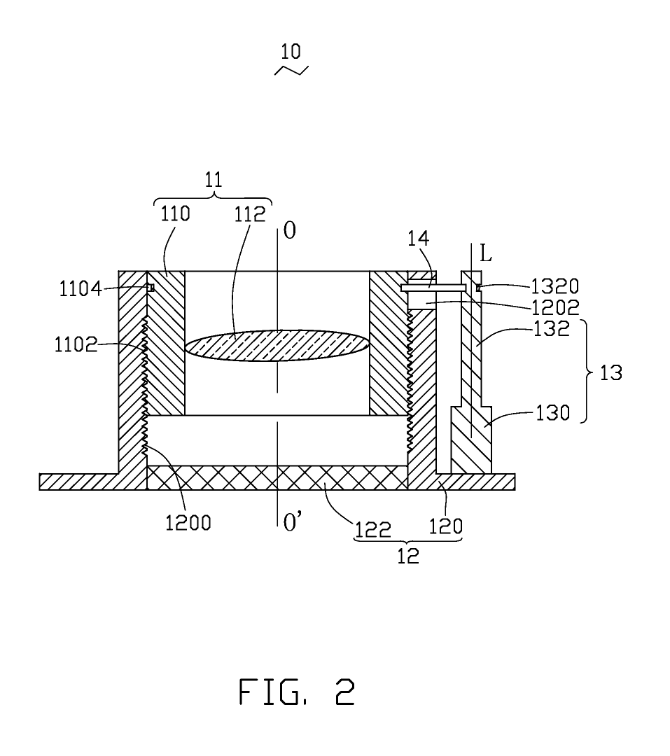

Referring to FIGS. 1 and 2, an exemplary camera module 10 according to a first embodiment includes a first lens module 11, an image sensor module 12 for detecting light from the first lens module 11, a first motor 13, and a first endless belt 14.

The first lens module 11 includes a first lens barrel 110 and at least one first lens 112. In the illustrated embodiment, the first lens module 11 includes a first lens 112. It is to be understood that lenses of any number and type could be used in the first lens barrel 110. The first lens barrel 110 is substantially a hollow cylinder. The first lens barrel 110 has outer threads 1102 on an outer wall thereof. The first lens 112 is engagingly received in the first lens barrel 110. The first lens 112 has an optical axis OO′.

The image sensor module 12 includes a lens holder 120 and an image sensor 122. The lens holder 120 has inner threads 1200 at an inner wall thereof, thus facilitating engagement with the outer threads 1102 of the first lens barrel 110. The image sensor 122 is received in the bottom portion of the lens holder 120 facing the first lens 112. The image sensor 122 is selected from a charge coupled device (CCD) and a complementary metal oxide semiconductor transistor (CMOS).

The first motor 13 is attached to the lens holder 120. In the present embodiment, the first motor 13 is a step motor. The first motor 13 includes a first body 130 and a first rotor 132 attached to the first body 130. The first rotor 132 can rotate relative to the first body 130. In the present embodiment, the first body 130 and the first rotor 132 are substantially cylinders. It is to be understood that, the shape of the first body 130 and first rotor 132 also can be any types, such as cubic or prismoid. The first rotor 132 has at least one first rotor slot 1320 defined in the outer cylinder surface of the first rotor 132. The rotating axis L of the first rotor 132 is parallel to the optical axis OO′ of the first lens module 11.

In the present embodiment, at least one first annular groove 1104 is defined in the outer wall of the first lens barrel 110. A first aperture 1202 is defined in the sidewall of the lens holder 120. The first annular groove 1104, the first aperture 1202, and the first rotor slot 1320 are substantially coplanar with each other. Part of the first endless belt 14 is fitted around the first lens barrel 110 and embedded in the first annular groove 1104, and another part of the first endless belt 14 passes through the first aperture 1202 of the lens holder 120 and is fitted around the first rotor 132 and embedded in the first rotor slot 1320.

In operation, when a change of the focal length of the first lens module 11 is desired, a voltage may be applied to the first motor 13. The first rotor 132 is driven by the first motor 13 to rotate. Due to the friction force between the first endless belt 14 and the first rotor 132, the first endless belt 14 is rotated with the first rotor 132. Due to the friction force between the first endless belt 14 and the first annular groove 1104 in the first lens barrel 110, the first lens barrel 110 is rotated with the first endless belt 14. The lens barrel 11 can be rotated in or out of the lens holder 120, such that the first lens 112 moves relative to the image sensor device 122. Thereby, the internal spacing between the first lens 112 and the image sensor 122 is changed, and the focal length of the camera module 10 is adjusted. The adjusting range of the focal length of the camera module 10 may be configured to be proportional to the number of the turns of the first rotor 132. That is, the focal length of the camera module 10 can be adjusted continuously.

It is to be understood that, the camera module 10 can includes more lens modules to provide better optical performance.

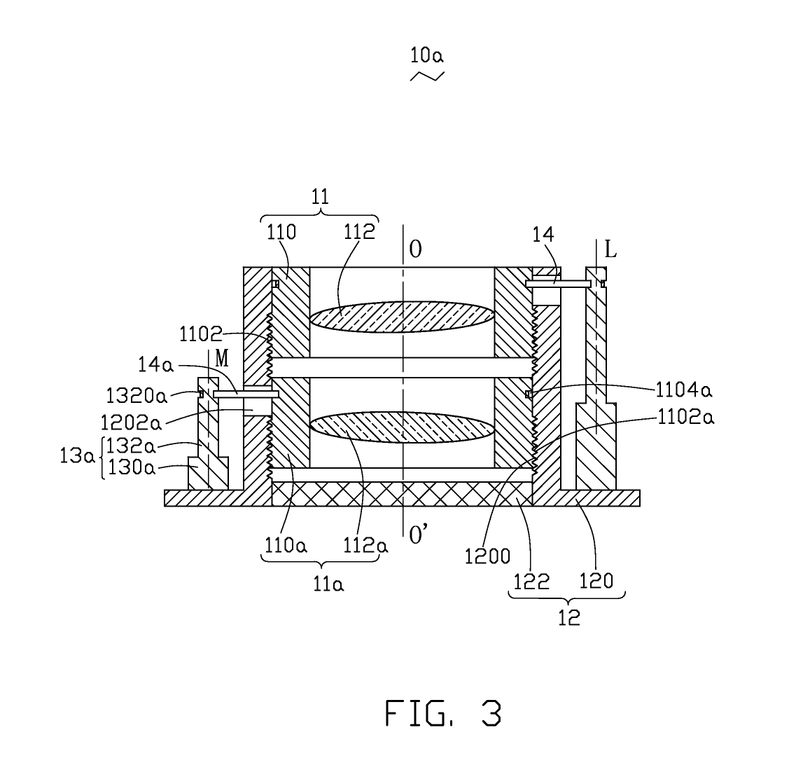

Referring to FIG. 3, an exemplary camera module 10a according to a second embodiment includes a first lens module 11, an image sensor module 12 for detecting light from the first lens module 11, a first motor 13, and a first endless belt 14. The difference with the camera module 10 in the first embodiment is that the camera module 10a further includes a second lens module 11a, a second motor 13a, and a second endless belt 14a.

The second lens module 11a includes a second lens barrel 110a, a second lens 112a received in the second lens barrel 110a. The first lens barrel 110 and the second lens barrel 110a are optically aligned with each other and engagingly received in the lens holder 120 by threads 1102, 1102a at the outer wall thereof. In the present embodiment, the second lens barrel 110a is disposed between the first lens barrel 110 and the image sensor 122. It is to be understood that, the first lens barrel 110 can also be disposed between the second lens barrel 110a and the image sensor 122.

The second motor 13a is attached to the lens holder 120 and spaced from the first motor 13. The second motor 13a includes a second body 130a and a second rotor 132a attached to the second body 130a. In the present embodiment, the second body 130a and the second rotor 132a are substantially cylinders. The second rotor 132a has at least one second rotor slot 1320a defined in the outer cylinder surface of the second rotor 132a. The rotating axis M of the second rotor 132a is parallel to the optical axis OO′ of the second lens module 11a.

In the present embodiment, at least one second annular groove 1104a is defined in the outer wall of the second lens barrel 110a. A second aperture 1202a is defined in the sidewall of the lens holder 120. The second annular groove 1104a, the second aperture 1202a, and the second rotor slot 1320a are substantially coplanar with each other. Part of the second endless belt 14a is fitted around the first endless belt 14a passes through the second aperture 1202a of the lens holder 120a and is fitted around the second rotor 132a and embedded in the second rotor slot 1320a.

In operation, the internal spacing between the first lens 112, the second lens 112a, and the image sensor device 122 can be adjusted by the first motor 13 and the second motor 13a. The adjusting range of the focal length of the camera module 10a may be configured to be proportional to the number of the turns of the first rotor 132 and the second rotor 132a. Thereby, the camera module 10a can achieved auto focusing or auto zooming functions. A height of each of the first motor 13 and the second motor 13a, can be designed according to the total length required for the lens modules.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A camera module, comprising:
a lens holder, an aperture being defined in a sidewall of the lens holder,
at least one lens module threadedly installed in the lens holder,
a motor mounted on the lens holder, the motor comprising a rotor and an endless belt,
wherein the endless belt extends through the aperture and surrounds the lens module and the rotor, and the motor is configured for driving the lens module to move relative to the lens holder.

2. The camera module as described in claim 1, wherein the lens module comprises a lens barrel and at least one lens engagingly received in the lens barrel.

3. The camera module as described in claim 2, wherein at least one annular groove is defined in an outer wall of the lens barrel, part of the endless belt is engaged in the annular groove.

4. The camera module as described in claim 1, wherein at least one rotor slot is defined in an outer surface of the rotor, part of the endless belt is engaged in the rotor slot.

5. The camera module as described in claim 1, further comprising an image sensor for detecting light from the lens module.

6. The camera module as described in claim 5, wherein the image sensor is a CCD or a CMOS.

7. The camera module as described in claim 1, wherein the motor is a step motor.

8. The camera module as described in claim 1, wherein the lens module has an optical axis, a rotating axis of the rotor being parallel to the optical axis of the lens module.
